(19) United States
(12) Patent Application Publication
(10) Pub. No.: US 2021/0108657 A1
(43) Pub. Date: Apr. 15, 2021

(54) FLUID CIRCUIT FOR AIR CYLINDERS

(71) Applicant: SMC CORPORATION, Chiyoda-ku (JP)

(72) Inventors: Yoshiyuki TAKADA, Ichikawa-shi (JP); Youji TAKAKUWA, Kitakatsushika-gun (JP); Hiroyuki ASAHARA, Tsukuba-shi (JP); Kengo MONDEN, Ushiku-shi (JP); Kazutaka SOMEYA, Kashiwa-shi (JP)

(73) Assignee: SMC CORPORATION, Chiyoda-ku (JP)

(21) Appl. No.: 16/644,658

(22) PCT Filed: May 18, 2018
(86) PCT No.: PCT/JP2018/019259

§ 371 Date: Mar. 5, 2020

(30) Foreign Application Priority Data
Sep. 7, 2017 (JP) 2017-171691

(51) Int. Cl. F15B 21/14; F15B 13/02

(52) U.S. Cl. CPC F15B 21/14; F15B 13/027; F15B 2211/7053; F15B 2211/30505; F15B 2211/40515; F15B 2211/3058

(57) ABSTRACT

A fluid circuit for air cylinders is provided with a switching valve, an air supply source, an exhaust port and a check valve. When the switching valve is in a first position, one cylinder chamber is connected with the air supply source and the other cylinder chamber is connected with the exhaust port. When the switching valve is in a second position, the one cylinder chamber is connected with the other cylinder chamber via the check valve, and the one cylinder chamber is connected with the exhaust port. The acoustic velocity conductance of a pipe connecting the switching valve and a cylinder port part of the one cylinder chamber is lower than the acoustic velocity conductance of the switching valve and the cylinder port part of the one cylinder chamber.

### TECHNICAL FIELD

The present invention relates to an air cylinder fluid circuit (a fluid circuit for air cylinders), and, in particular, relates to a fluid circuit for a double-acting air cylinder that does not require large driving force in the return step.

### BACKGROUND ART

Conventionally, a drive device for a double-acting pneumatic actuator that requires large output in the drive step while not requiring large output in the return step, has been known (see Japanese Utility Model Publication No. 02-002965).

The actuator drive device collects and accumulates part of exhaust air discharged from a drive-side pressure chamber of a double-acting cylinder device in an accumulator, and uses the part of the exhaust air as return power in the double-acting cylinder device. Specifically, when a switching valve is switched, high-pressure exhaust air inside the drive-side pressure chamber passes through a collection port of a collection valve and is accumulated in the accumulator. When the difference between the exhaust pressure and the pressure in the accumulator becomes small due to a reduction in the exhaust pressure, air remaining inside the drive-side pressure chamber is released to the atmosphere from an exhaust port of the collection valve, and, at the same time, the air accumulated in the accumulator flows into a return-side pressure chamber.

In the above-described actuator drive device, even when the switching valve is switched, the high-pressure air inside the drive-side pressure chamber is not released to the atmosphere until the difference between the exhaust pressure and the pressure in the accumulator becomes small. Thus, it disadvantageously takes time to obtain thrust force required to perform a return operation in the double-acting cylinder device. In addition, the collection valve having a complex structure is required.

In consideration of the aforementioned problems, the present applicant has filed a patent application for an invention of a drive device for reusing exhaust pressure to cause a fluid pressure cylinder to perform a return operation, having the objects of reducing time required for the return operation and of simplifying the circuit (Japanese Patent Application No. 2016-184211).

In addition, the present applicant has filed a patent application for an invention of an air cylinder fluid circuit which is designed such that a reference resistance thereof is determined by tubes and which has the object of reducing air consumption (Japanese Patent Application No. 2017-165113).

### SUMMARY OF INVENTION

The present invention has been devised in connection with the above-described patent applications, and has the object of providing an air cylinder fluid circuit capable of reducing air consumption as much as possible.

An air cylinder fluid circuit according to the present invention includes a switching valve, an air supply source, an exhaust port, and a check valve, wherein when the switching valve is in a first position, a first cylinder chamber communicates with the air supply source while a second cylinder chamber communicates with the exhaust port, and when the switching valve is in a second position, the first cylinder chamber communicates with the second cylinder chamber via the check valve while the first cylinder chamber also communicates with the exhaust port, and wherein a sonic conductance of a tube connecting a cylinder port portion of the first cylinder chamber with the switching valve is less than sonic conductances of the cylinder port portion of the first cylinder chamber and the switching valve.

According to the above-described air cylinder fluid circuit, air accumulated in the first cylinder chamber is supplied to the second cylinder chamber and also discharged to the outside. Thus, while the air consumption is reduced by reusing the air supplied from the air supply source to the first cylinder chamber, the time required for the return step in an air cylinder is shortened, and the circuit for returning the air cylinder can be simplified. Moreover, the fluid circuit can be designed such that the resistance of a flow channel extending from the cylinder port portion of the first cylinder chamber to the switching valve is mostly determined by the tube connecting the cylinder port portion with the switching valve, so that the need to provide a fixed orifice for the air cylinder is eliminated. Furthermore, since the inner diameter of the tube connecting the cylinder port portion of the first cylinder chamber with the switching valve is reduced, the amount of air discharged from the interior of the tube to the outside becomes small, and the air consumption can thus be reduced.

In the above-described air cylinder fluid circuit, an adjustable throttle valve is preferably disposed between the switching valve and the exhaust port. Owing to this, it is possible to change the ratio of the flow rate at which air accumulated in the first cylinder chamber is supplied toward the second cylinder chamber to the flow rate at which air accumulated in the first cylinder chamber is discharged to the outside.

Moreover, it is preferable that an upstream side of the check valve be connected to a tube branching off from the tube connecting the cylinder port portion of the first cylinder chamber with the switching valve, and that inner diameters of the tubes be smaller than inner diameters of a tube connecting a downstream side of the check valve with the switching valve and a tube connecting the switching valve with a cylinder port portion of the second cylinder chamber. Owing to this, the volume of the tube connecting the downstream side of the check valve with the switching valve and the volume of the tube connecting the switching valve with the cylinder port portion of the second cylinder chamber can be set to be larger. Thus, the air discharged from the first cylinder chamber can be accumulated in the tubes, and the pressure in the second cylinder chamber can be prevented from decreasing when the volume of the second cylinder chamber increases during the return step of the air cylinder.

Furthermore, an air tank is preferably disposed at a point on the tube connecting the switching valve with the cylinder port portion of the second cylinder chamber. Thus, the air discharged from the first cylinder chamber can be accumulated in the air tank, and the pressure in the second cylinder chamber can be prevented from decreasing when the volume of the second cylinder chamber increases during the return step of the air cylinder.

In accordance with the air cylinder fluid circuit according to the present invention, the air consumption can be reduced by reusing the air supplied to the first cylinder chamber, and the air consumption can be further reduced by reducing the amount of air discharged from the interior of the predetermined tubes to the outside. In addition, the circuit for retuning the air cylinder can be simplified, and no fixed orifice is required for the air cylinder.

The above-described object, features, and advantages will become more apparent from the following description of a preferred embodiment in conjunction with the accompanying drawings.

### BRIEF DESCRIPTION OF DRAWINGS

FIG. 1 is a circuit diagram illustrating an air cylinder fluid circuit according to an embodiment of the present invention;

FIG. 2 is a circuit diagram when a switching valve in FIG. 1 is in another position;

FIG. 3 is a graph illustrating a relationship between the sonic conductance and length of a tube for different inner diameters of the tube;

FIG. 4 is a detailed view of part of the air cylinder fluid circuit in FIG. 1; and

FIG. 5 is a diagram illustrating results of the air pressures in cylinder chambers and the piston stroke measured during operation of the air cylinder in FIG. 1.

### DESCRIPTION OF EMBODIMENT

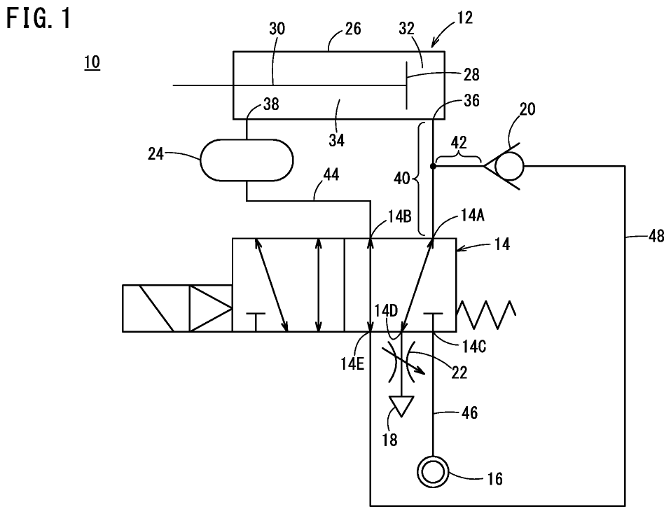

A preferred embodiment of an air cylinder fluid circuit, i.e., a fluid circuit for an air cylinder, according to the present invention will be described in detail below with reference to the accompanying drawings. In FIG. 1, reference numeral 10 denotes an air cylinder fluid circuit according to the embodiment of the present invention.

As illustrated in FIG. 1, the air cylinder fluid circuit 10 is applied to a double-acting air cylinder 12, and includes a switching valve 14, an air supply source 16 (compressor), an exhaust port 18, a check valve 20, an adjustable throttle valve 22, and an air tank 24.

The air cylinder 12 includes a piston 28 disposed inside a cylinder body 26 to be slidable in a reciprocal manner. One end portion of a piston rod 30 is connected to the piston 28, and another end portion thereof extends from the cylinder body 26 to the outside. The air cylinder 12 performs tasks such as positioning of workpieces (not illustrated) while pushing out the piston rod 30 (while advancing the piston rod), and does not perform any tasks while retracting the piston rod 30. The cylinder body 26 includes two cylinder chambers partitioned by the piston 28, that is, a head-side cylinder chamber 32 located on the opposite side of the piston from the piston rod 30 and a rod-side cylinder chamber 34 located on the same side as the piston rod 30.

The switching valve 14 has a first port 14A to a fifth port 14E and is configured as a solenoid valve switchable between a first position and a second position. The first port 14A is connected to a cylinder port portion 36 of the head-side cylinder chamber 32 by a first tube 40 and, at the same time, connected to the upstream side of the check valve 20 by a second tube 42 branching off from a point on the first tube 40. The second port 14B is connected to a cylinder port portion 38 of the rod-side cylinder chamber 34 by a third tube 44 in which the air tank 24 is disposed. The third port 14C is connected to the air supply source 16 by a fourth tube 46. The fourth port 14D is connected to the exhaust port 18 via the adjustable throttle valve 22. The fifth port 14E is connected to the downstream side of the check valve 20 by a fifth tube 48.

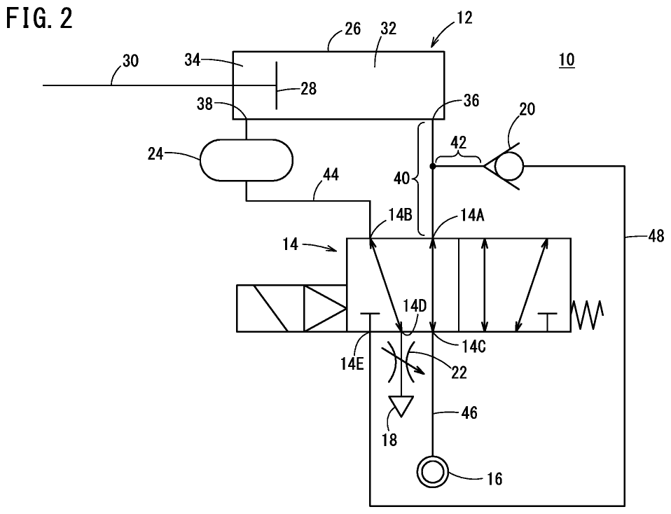

As illustrated in FIG. 1, when the switching valve 14 is in the first position, the first port 14A is connected to the fourth port 14D, and the second port 14B is connected to the fifth port 14E. As illustrated in FIG. 2, when the switching valve 14 is in the second position, the first port 14A is connected to the third port 14C, and the second port 14B is connected to the fourth port 14D. The switching valve 14 is held in the first position by the biasing force of a spring while not being energized, and switches from the first position to the second position when being energized.

When the switching valve 14 is in the first position, the check valve 20 allows air to flow from the head-side cylinder chamber 32 toward the rod-side cylinder chamber 34 and stops air flowing from the rod-side cylinder chamber 34 toward the head-side cylinder chamber 32.

The adjustable throttle valve 22 is configured to adjust the flow rate at which air is discharged from the exhaust port 18. By operating the adjustable throttle valve 22, the ratio of the flow rate at which air accumulated in the head-side cylinder chamber 32 is discharged to the outside, to the flow rate at which air accumulated in the head-side cylinder chamber 32 is supplied to the rod-side cylinder chamber 34 can be changed.

The air tank 24 is provided to accumulate air supplied from the head-side cylinder chamber 32 toward the rod-side cylinder chamber 34. The air tank 24 substantively increases the volume of the rod-side cylinder chamber 34.

The resistance of a flow channel extending from the cylinder port portion 36 of the head-side cylinder chamber 32 to the switching valve 14 is an important factor that affects the operating speed of the air cylinder 12 during the drive step. The resistance is designed to be affected by the first tube 40 the most. That is, the sonic conductance of the first tube 40 is designed to be less than the sonic conductances of the cylinder port portion 36 of the head-side cylinder chamber 32 and the switching valve 14. In particular, in a case where the sonic conductance of the first tube 40 is less than or equal to half the sonic conductance of each of the above-described circuit elements, the resistance of the flow channel extending from the cylinder port portion 36 of the head-side cylinder chamber 32 to the switching valve 14 is determined by the first tube 40 and is not affected by the above-described circuit elements.

Here, sonic conductance is a predetermined coefficient in flow rate calculation formula defined by ISO and adopted by JIS (JIS B 8390-2000) in 2000, and is an index indicating how easily the air can flow as is the effective area or the CV value. The unit of sonic conductance is dm³/(s·bar). A lower sonic conductance means a higher resistance to air flow.

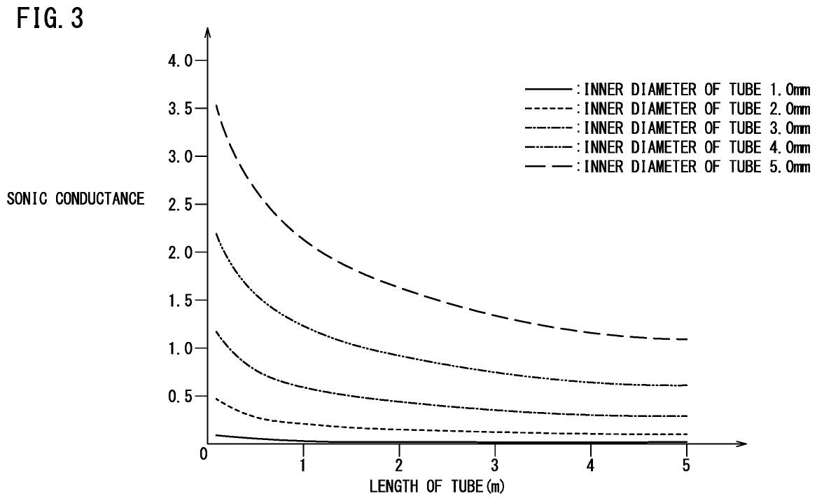

Next, the sonic conductance of a tube will be described. FIG. 3 shows a relationship between the sonic conductance of a tube and the length of the tube for different inner diameters of the tube. Specifically, the figure indicates the value of the sonic conductance obtained when the length of the tube is changed from 0.1 to 5.0 m for cases where the inner diameters of the tube are 5.0 mm, 4.0 mm, 3.0 mm, 2.0 mm, and 1.0 mm. As shown in FIG. 3, the sonic conductance decreases as the length of the tube increases and as the inner diameter of the tube decreases. For example, when the length of the tube is 2 m, the sonic conductance takes values of 1.63, 0.92, 0.44, 0.15, and 0.02 respectively for the above inner diameters of the tube.

The sonic conductances of the circuit elements on the flow channel extending from the cylinder port portion 36 of the head-side cylinder chamber 32 to the switching valve 14 including the first tube 40 are designed, for example, as follows.

The inner diameter and length of the first tube 40 are set to 3.0 mm and 2.0 m, respectively. With this condition, the sonic conductance of the first tube 40 becomes 0.44. The length of the first tube 40 is basically determined according to an installation state where the air cylinder 12 and the switching valve 14 are installed (distance between the air cylinder 12 and the switching valve 14).

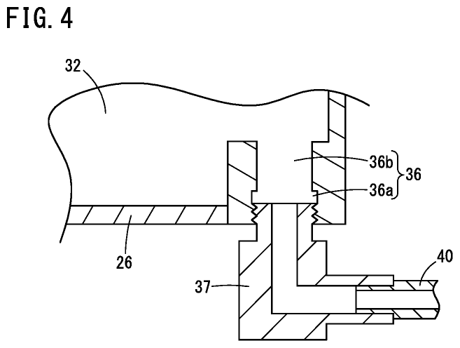

As illustrated in FIG. 4, the cylinder port portion 36 of the head-side cylinder chamber 32 includes an opening part 36a for connecting the first tube 40 and a hole part 36b adjoining the opening part 36a. By setting the diameter of the hole part 36b to 10.9 mm, the sonic conductance of the cylinder port portion 36 of the head-side cylinder chamber 32 becomes 16.8. Conventionally, the diameter of the hole part has been designed to be about 2 mm so that the cylinder port portion may function as a fixed orifice. The sonic conductance of the adopted switching valve 14 is 1.92. In FIG. 4, a member with reference numeral 37 is a fitting.

According to the above-described design example, the sonic conductance of the first tube 40 is designed to be less than or equal to half the sonic conductance of each of the cylinder port portion 36 of the head-side cylinder chamber 32 and the switching valve 14. Thus, the resistance of the flow channel extending from the cylinder port portion 36 of the head-side cylinder chamber 32 to the switching valve 14 is determined by the first tube 40.

The inner diameter of the second tube 42 is approximately as large as the inner diameter of the first tube 40. On the other hand, the inner diameters of the third tube 44, the fourth tube 46, and the fifth tube 48 are larger than the inner diameter of the first tube 40. The inner diameters of the third tube 44, the fourth tube 46, and the fifth tube 48 are, for example, 5.0 mm. By increasing the inner diameters of the third tube 44 and the fifth tube 48 to sufficiently increase the volumes thereof, air supplied from the head-side cylinder chamber 32 toward the rod-side cylinder chamber 34 can also be accumulated in the third tube 44 and the fifth tube 48 in addition to the air tank 24. The cylinder port portion 38 of the rod-side cylinder chamber 34 does not need to function as a fixed orifice, and the diameter of the hole part may be approximately as large as the cylinder port portion 36 of the head-side cylinder chamber 32.

The air cylinder fluid circuit 10 according to the embodiment of the present invention and the design example have been described above. Next, the operations and operational effects thereof will be described. A state where the piston rod 30 is retracted the most as illustrated in FIG. 1 is defined as an initial state.

In this initial state, when the switching valve 14 is energized to switch from the first position to the second position, air from the air supply source 16 is supplied to the head-side cylinder chamber 32 through the first tube 40, and air in the rod-side cylinder chamber 34 is discharged from the exhaust port 18 through the third tube 44 and the adjustable throttle valve 22. As illustrated in FIG. 2, the piston rod 30 is advanced to the maximum position and is held in the position by a large thrust.

When the energization of the switching valve 14 is stopped after the piston rod 30 is advanced to perform a task such as positioning of a workpiece, the switching valve 14 is switched from the second position to the first position. Then, part of the air accumulated in the head-side cylinder chamber 32 is supplied toward the rod-side cylinder chamber 34 through the first tube 40, the second tube 42, and the check valve 20. At the same time, the other part of the air accumulated in the head-side cylinder chamber 32 is discharged from the exhaust port 18 through the first tube 40 and the adjustable throttle valve 22. At this time, the air supplied toward the rod-side cylinder chamber 34 is first accumulated in the fifth tube 48, the third tube 44, and the air tank 24. This is because the volume of the rod-side cylinder chamber 34 is extremely small before retraction of the piston rod 30 starts. Subsequently, the air pressure P1 in the head-side cylinder chamber 32 decreases, and the air pressure P2 in the rod-side cylinder chamber 34 increases. When the air pressure P2 in the rod-side cylinder chamber 34 reaches a level higher than the air pressure P1 in the head-side cylinder chamber 32 by a predetermined amount, retraction of the piston rod 30 starts. Then, the piston rod 30 returns to the initial state where the piston rod 30 is retracted the most.

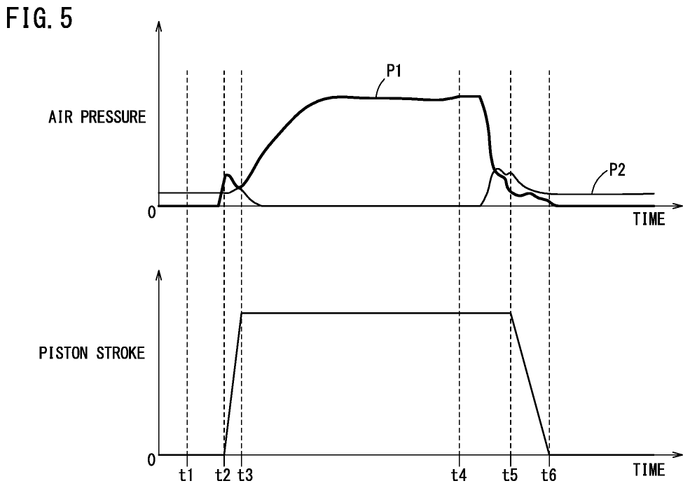

The air pressure P1 in the head-side cylinder chamber 32, the air pressure P2 in the rod-side cylinder chamber 34, and the piston stroke were measured during the above-described series of operations. FIG. 5 illustrates the results. The principle of operation of the air cylinder 12 will be described in detail below with reference to FIG. 5. In FIG. 5, the zero point of the air pressure indicates that the air pressure is equal to the atmospheric pressure, and the zero point of the piston stroke indicates that the piston rod 30 is in the most retracted position.

At time t1 when a command to energize the switching valve 14 is issued, the air pressure P1 in the head-side cylinder chamber 32 is equal to the atmospheric pressure, and the air pressure P2 in the rod-side cylinder chamber 34 is slightly higher than the atmospheric pressure.

When the switching valve 14 is switched from the first position to the second position in response to the command to energize the switching valve 14, the air pressure P1 in the head-side cylinder chamber 32 starts increasing. At time t2, the air pressure P1 in the head-side cylinder chamber 32 exceeds the air pressure P2 in the rod-side cylinder chamber 34 by an amount to overcome static frictional resistance of the piston 28, and the piston rod 30 then starts moving in a push-out direction. Subsequently, at time t3, the piston rod 30 is advanced to the maximum. The air pressure P1 in the head-side cylinder chamber 32 keeps increasing and then becomes constant. The air pressure P2 in the rod-side cylinder chamber 34 drops and then becomes equal to the atmospheric pressure. Between the time t2 and the time t3, the air pressure P1 in the head-side cylinder chamber 32 temporarily drops, and the air pressure P2 in the rod-side cylinder chamber 34 temporarily increases. The drop and increase are considered to be respectively caused by an increase in the volume of the head-side cylinder chamber 32 and a reduction in the volume of the rod-side cylinder chamber 34.

At time t4, a command to stop the energization of the switching valve 14 is issued and the switching valve 14 is switched from the second position to the first position. In response to this, the air pressure P1 in the head-side cylinder chamber 32 starts dropping, and the air pressure P2 in the rod-side cylinder chamber 34 starts increasing. When the air pressure P1 in the head-side cylinder chamber 32 becomes equal to the air pressure P2 in the rod-side cylinder chamber 34, supply of the air in the head-side cylinder chamber 32 toward the rod-side cylinder chamber 34 is stopped due to the effect of the check valve 20, and the air pressure P2 in the rod-side cylinder chamber 34 stops increasing. On the other hand, the air pressure P1 in the head-side cylinder chamber 32 keeps dropping. At time t5, the air pressure P2 in the rod-side cylinder chamber 34 exceeds the air pressure P1 in the head-side cylinder chamber 32 by an amount to overcome the static frictional resistance of the piston 28, and the piston rod 30 starts moving in a retraction direction.

When the piston rod 30 starts moving in the retraction direction, the volume of the rod-side cylinder chamber 34 increases and thus the air pressure P2 in the rod-side cylinder chamber 34 drops. However, since the air pressure P1 in the head-side cylinder chamber 32 drops at a higher rate than the air pressure P2, the air pressure P2 in the rod-side cylinder chamber 34 keeps exceeding the air pressure P1 in the head-side cylinder chamber 32. Since the sliding resistance of the piston 28 that is moving is less than the frictional resistance of the piston 28 at rest, the piston rod 30 is able to move in the retraction direction without any problems. Then, at time t6, the piston rod 30 returns to a state of being retracted the most. At this time, the air pressure P1 in the head-side cylinder chamber 32 is equal to the atmospheric pressure, and the air pressure P2 in the rod-side cylinder chamber 34 is slightly higher than the atmospheric pressure. This condition is maintained until a next command to energize the switching valve 14 is issued.

Next, an effect of reducing air consumption will be described. Part of the air supplied from the air supply source 16 and accumulated in the head-side cylinder chamber 32 during the drive step of the air cylinder 12 is supplied to the rod-side cylinder chamber 34 during the return step. This is a first factor contributing to a reduction in the air consumption. Immediately before the return step is completed, that is, immediately after the piston rod 30 has been retracted the most, air in the first tube 40 and the second tube 42 is discharged from the exhaust port 18 until the air pressure therein decreases to the atmospheric pressure. However, the amount of discharged air is small since the inner diameters of the first tube 40 and the second tube 42 are small. This is a second factor contributing to a reduction in the air consumption.

To examine how much the air consumption is reduced, the air cylinder fluid circuit was compared with a circuit having a typical configuration in which air supplied from the air supply source to the head-side cylinder chamber during the drive step was not reused during the return step and in which all the inner diameters of the tubes connected to the air cylinder were set to 5.0 mm. Based on the premise that the inner diameter of the air cylinder was 50 mm, when the air consumption of the circuit used for comparison was taken as 100, the air consumption of this embodiment was 38. That is, the air consumption was reduced by 45% by the first factor and by 17% by the second factor. When the inner diameter of the air cylinder was changed from 50 mm to 45 mm, the air consumption was further reduced by 8%.

According to this embodiment, part of the air supplied from the air supply source 16 in the head-side cylinder chamber 32 and accumulated therein is supplied to the rod-side cylinder chamber 34 during the return step. This reduces the air consumption. Moreover, since the inner diameters of the first tube 40 and the second tube 42 are small, the amount of air in the first tube 40 and the second tube 42 discharged from the exhaust port 18 is small. This further reduces the air consumption.

Yet moreover, the resistance of the flow channel extending from the cylinder port portion 36 of the head-side cylinder chamber 32 to the switching valve 14 is mostly determined by the first tube 40. Thus, no fixed orifice is required for the air cylinder 12.

Furthermore, air supplied from the head-side cylinder chamber 32 toward the rod-side cylinder chamber 34 can be accumulated in the third tube 44, the fifth tube 48, and the air tank 24. Thus, the pressure in the rod-side cylinder chamber 34 can be prevented from decreasing when the volume of the rod-side cylinder chamber 34 increases during the return step of the air cylinder 12.

In this embodiment, the adjustable throttle valve 22 and the air tank 24 are provided. However, they need not necessarily be provided. In addition, the inner diameter of the second tube 42 is substantially the same as the inner diameter of the first tube 40. However, the inner diameter of the second tube 42 may be larger than the inner diameter of the first tube 40. The air cylinder fluid circuit according to the present invention is not limited in particular to the embodiment described above, and may have various configurations without departing from the scope of the present invention as a matter of course.

1. An air cylinder fluid circuit comprising:
a switching valve;
an air supply source;
an exhaust port; and
a check valve;
wherein when the switching valve is in a first position, a first cylinder chamber communicates with a second cylinder chamber via the check valve, while the first cylinder chamber also communicates with the exhaust port, and when the switching valve is in a second position, the first cylinder chamber communicates with the air supply source while the second cylinder chamber communicates with the exhaust port; and
wherein a sonic conductance of a tube connecting a cylinder port portion of the first cylinder chamber with the switching valve is less than sonic conductances of the cylinder port portion of the first cylinder chamber and the switching valve.

2. The air cylinder fluid circuit according to claim 1, wherein an adjustable throttle valve is disposed between the switching valve and the exhaust port.

3. The air cylinder fluid circuit according to claim 1, wherein an upstream side of the check valve is connected to a tube branching off from the tube connecting the cylinder port portion of the first cylinder chamber with the switching valve, and inner diameters of the tubes are smaller than inner diameters of a tube connecting a downstream side of the check valve with the switching valve and a tube connecting the switching valve with a cylinder port portion of the second cylinder chamber.

4. The air cylinder fluid circuit according to claim 1, wherein an air tank is disposed at a point on a tube connecting the switching valve with a cylinder port portion of the second cylinder chamber.
